(19) United States
(12) Patent Application Publication
(10) Pub. No.: US 2026/0251214 A1
(43) Pub. Date: Aug. 27, 2026

(54) ELECTRIC DRIVE DEVICE

(71) Applicant: HONDA MOTOR CO., LTD., Tokyo (JP)

(72) Inventor: Ryuzaburo KOBAYASHI, Saitama (JP)

(21) Appl. No.: 19/386,804

(22) Filed: Nov. 12, 2025

(30) Foreign Application Priority Data
Feb. 21, 2025 (JP) 2025-027133

(51) Int. Cl. F16H 57/04; B64D 27/34; B64D 35/021; F16H 1/28; F16H 57/02; F16H 57/021

(52) U.S. Cl. CPC F16H 57/0486; B64D 27/34; B64D 35/021; F16H 1/28; F16H 57/021; F16H 57/0426; F16H 57/043; F16H 57/0436; F16H 57/045; F16H 2057/02034; F16H 2057/02043

(57) ABSTRACT

An electric drive device includes: an electric motor including a rotation shaft; a drive shaft having a rotor fixed to one end side thereof; a transmission mechanism connected to the rotation shaft and the drive shaft and configured to transmit an output torque of the electric motor from the rotation shaft to the drive shaft; a case; and a first shaft support portion and a second shaft support portion rotatably supporting the drive shaft and supported by the case. The rotation shaft is formed in a hollow tubular shape. The drive shaft is inserted inside the rotation shaft. The first shaft support portion is arranged closer to the one end side of the drive shaft than the rotation shaft, and the second shaft support portion is arranged closer to the other end side of the drive shaft than the rotation shaft.

### TECHNICAL FIELD

The present invention relates to an electric drive device including an electric motor having a rotation shaft, a drive shaft to which a rotor is fixed, and a transmission mechanism coupled to the rotation shaft and the drive shaft and transmitting an output torque of the electric motor from the rotation shaft to the drive shaft.

### BACKGROUND ART

In recent years, efforts to realize a low-carbon or carbon-free society have been gaining momentum, and research and development of electrification technologies is being conducted for vehicles, aircraft, and the like to reduce CO₂ emissions and improve energy efficiency.

In the aircraft, a motor is used to rotate a propeller. For example, FIG. 7A of JP2022-67637A discloses an electric propulsion unit including a motor shaft of the motor and a propeller shaft to which the propeller is fixed. In the electric propulsion unit, the driving force of the motor is transmitted to the propeller shaft by meshing of a main drive gear mounted to a distal end of the motor shaft of the motor and a propeller shaft drive gear mounted to a rear end of the propeller shaft.

When the propeller rotates, the propeller generates external force and vibration on the propeller shaft. The propeller shaft needs to be firmly supported so as to withstand vibrations. In the electric propulsion unit shown in FIG. 7A of JP2022-67637A, since the propeller shaft is mounted to the distal end of the motor shaft, a mechanism for firmly supporting the propeller shaft needs to be provided at the distal end of the motor shaft. This poses a problem of increasing the size of the electric propulsion unit.

### SUMMARY OF THE INVENTION

In view of the above background, an object of the present invention is to provide an electric drive device including a drive shaft to which a rotor is fixed, and an electric motor that drives the drive shaft, and capable of achieving both firm support of the drive shaft and compactness. This in turn contributes to improving energy efficiency.

To achieve such an object, one aspect of the present invention provides an electric drive device comprising: an electric motor including a rotation shaft; a drive shaft having a rotor fixed to one end side thereof; a transmission mechanism connected to the rotation shaft and the drive shaft and configured to transmit an output torque of the electric motor from the rotation shaft to the drive shaft; a case; and a first shaft support portion and a second shaft support portion rotatably supporting the drive shaft and supported by the case at positions spaced apart from each other in an axial direction of the drive shaft. The rotation shaft is formed in a hollow tubular shape extending in the axial direction, and is arranged between the first shaft support portion and the second shaft support portion in the axial direction, the drive shaft is inserted inside the rotation shaft and is arranged coaxially with the rotation shaft, and the first shaft support portion is arranged closer to the one end side of the drive shaft than the rotation shaft, and the second shaft support portion is arranged closer to the other end side of the drive shaft than the rotation shaft.

Thus, according to the above aspects, it is possible to provide the electric drive device including the drive shaft to which the rotor is fixed, and the electric motor that drives the drive shaft, and capable of achieving both firm support of the drive shaft and compactness.

### BRIEF DESCRIPTION OF THE DRAWING(S)

FIG. 1 is a perspective view showing an aircraft according to a first embodiment of the present invention;

FIG. 2 is a perspective view of a base and an electric drive device;

FIG. 3 is a cross-sectional view of the electric drive device;

FIG. 4 is a perspective cross-sectional view of an upper lid;

FIG. 5 is a perspective view of a drive shaft;

FIG. 6 is a perspective view of a transmission mechanism;

FIG. 7 is a cross-sectional view of the transmission mechanism;

FIG. 8A is a cross-sectional view of a bottom of a case when a drive shaft 17 is not rotating;

FIG. 8B is a cross-sectional view of the bottom of the case when the drive shaft is rotating;

FIG. 9 is a cross-sectional view of the electric drive device according to a second embodiment of the present invention;

FIG. 10 is an exploded perspective view of the transmission mechanism; and

FIG. 11 is a cross-sectional view of the transmission mechanism.

### DETAILED DESCRIPTION OF THE INVENTION

### First Embodiment

### An Aircraft 1

In the following, an aircraft 1 according to a first embodiment of the present invention will be described with reference to the drawings. In the drawings and the following description, directions such as forward, rearward, left, right, up, and down are directions defined relative to the aircraft 1.

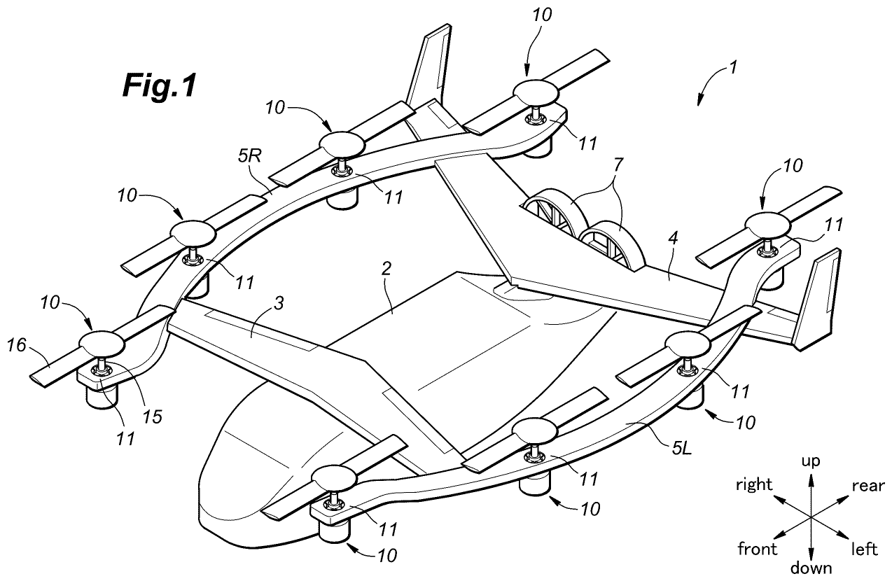

FIG. 1 is a perspective view showing the aircraft 1 according to the first embodiment of the present invention. As shown in FIG. 1, the aircraft 1 is an electric vertical take-off and landing aircraft (eVTOL aircraft) capable of taking off and landing vertically. The aircraft 1 includes a body 2 extending in the front-and-rear direction, a front wing 3 extending in the lateral direction and connected to the front portion of the body 2, a rear wing 4 extending in the lateral direction and connected to the rear portion of the body 2, a left arm 5L extending in the front-and-rear direction and connecting the left end of the front wing 3 to the left side portion of the rear wing 4, and a right arm 5R extending in the front-and-rear direction and connecting the right end of the front wing 3 to the right side portion of the rear wing 4. The front wing 3 and the rear wing 4 are formed in a shape that generates lifting force when moving forward.

A cabin (not shown) for an occupant to board is provided in the front portion of the body 2. Left and right rear propulsion force generators 7 for applying the forward propulsion force to the aircraft 1 are provided at the rear end of the body 2.

The left arm 5L and the right arm 5R are each provided with a plurality of (for example, four) electric drive devices 10 at intervals in the front-and-rear direction. Each electric drive device 10 applies ascending and descending forces to the aircraft 1. The left arm 5L and the right arm 5R are provided with a plurality of bases 11, each provided with an electric drive device 10.

Each base 11 has the same configuration. Further, each electric drive device 10 has the same configuration. One electric drive device 10 will be described below.

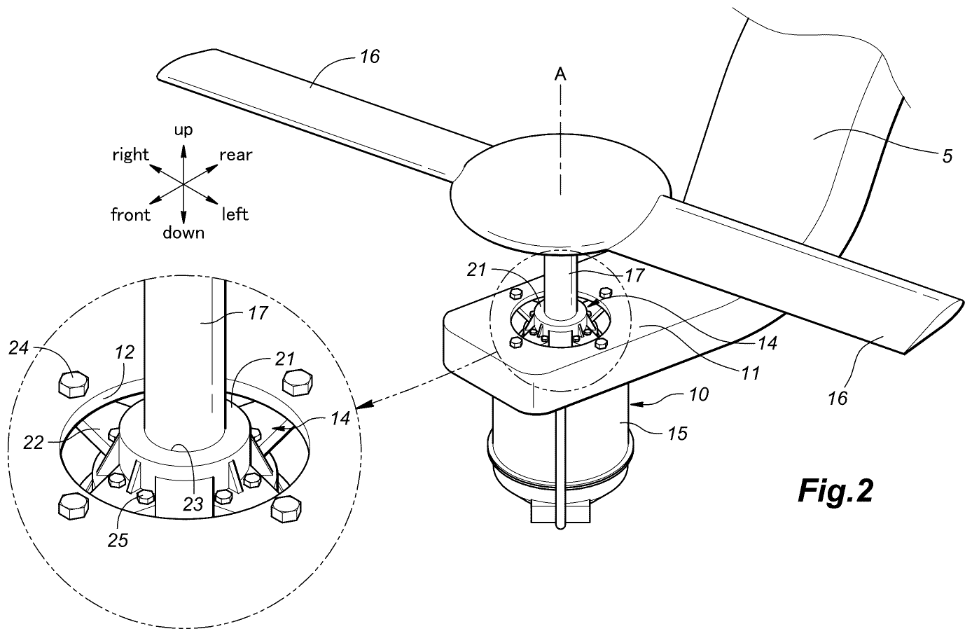

FIG. 2 is a perspective view of the base 11 and the electric drive device 10. As shown in FIG. 2, the base 11 is provided on the arm 5 and formed in a plate shape. The base 11 includes an attachment hole 12 extending in the up-and-down direction. The attachment hole 12 is a circular hole. A support portion 14 is removably attached to the base 11. The electric drive device 10 is attached to the base 11 via the support portion 14.

Each electric drive device 10 includes a case 15, and a drive shaft 17 extending in the up-and-down direction, rotatably supported by the case 15, and having a rotor 16 fixed to the upper end (one end) side thereof.

The support portion 14 includes a tubular main body 21 that rotatably supports the drive shaft 17, and four arm portions 22 that extend radially outward from the main body 21. The main body 21 is formed in a cylindrical shape that extends in the up-and-down direction. The main body 21 is provided with a bearing hole 23 extending vertically through the center thereof. The bearing hole 23 is provided with the bearing (not shown). The drive shaft 17 is rotatably supported in the bearing hole 23 via the bearing.

Four arm portions 22 extend radially from the lower end of the main body 21. Each arm portion 22 is connected to the main body 21. Each arm portion 22 is fastened to the base 11 by the fastener 24, such as a bolt and nut. Accordingly, the main body 21 is supported by the base 11 via a plurality of arm portions 22. Each arm portion 22 is fastened to the case 15 by a fastener 25, such as a bolt and nut. Accordingly, the electric drive device 10 is fixed to the base 11 via the arm portion 22. Each electric drive device 10 rotates the rotor 16 together with the drive shaft 17 to apply the ascending and descending forces to the aircraft 1.

### The Electric Drive Device 10

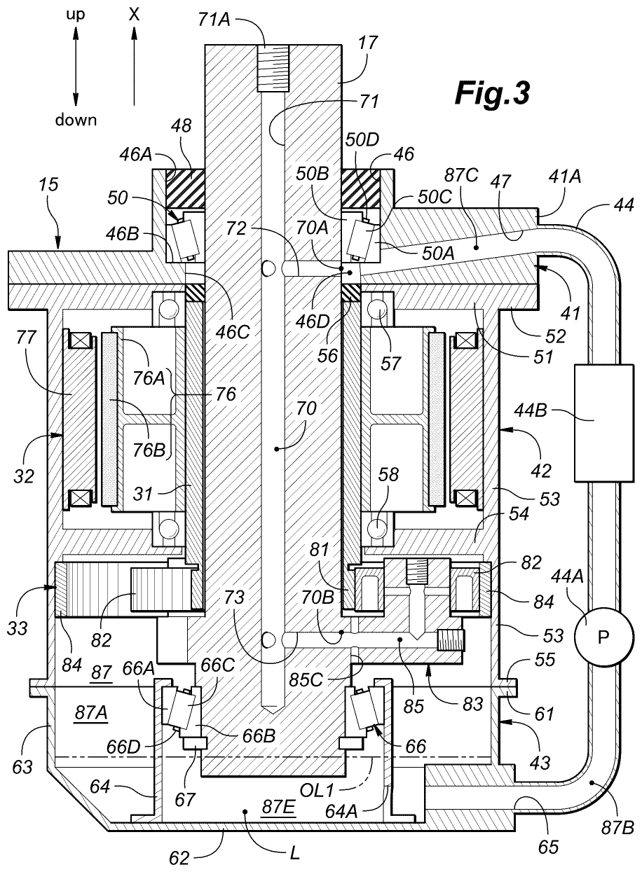

FIG. 3 is a schematic cross-sectional view of the electric drive device 10. As shown in FIG. 3, the electric drive device 10 includes the case 15, the drive shaft 17 extending in the up-and-down direction and having the rotor 16 (not shown in FIG. 3) fixed to the upper end (one end) side thereof and, an electric motor 32 including a rotation shaft 31, and a transmission mechanism 33 connected to the rotation shaft 31 and the drive shaft 17 and transmitting the output torque of the electric motor 32 from the rotation shaft 31 to the drive shaft 17. The drive shaft 17 and the rotation shaft 31 are arranged coaxially. The direction in which the rotation axes of the drive shaft 17 and the rotation shaft 31 extend is defined as an axial direction X. The axial direction X is the up-and-down direction.

The case 15 includes an upper lid 41, a cylindrical case body 42 coupled to the upper lid 41, and a lower lid 43 coupled to the case body 42. The upper lid 41 and the lower lid 43 are connected to an oil pipe 44.

The upper lid 41 is formed in a disk-like shape having a surface facing the up-and-down direction. The upper lid 41 includes a through hole 46 extending in the up-and-down direction, and an oil through hole 47 extending from a side surface 41A of the upper lid 41 to the through hole 46 in a direction intersecting the up-and-down direction.

The through hole 46 includes a first through hole 46A in the upper portion, a shoulder 46B extending radially inward from the lower end of the first through hole 46A, and a second through hole 46C extending downward from the radial inner end of the shoulder 46B. The inner diameter of the first through hole 46A is larger than the inner diameter of the second through hole 46C.

An oil seal 48 is provided at the upper end of the first through hole 46A to seal between the drive shaft 17 and the first through hole 46A. A first tapered roller bearing 50 (a first shaft support portion) that rotatably supports the drive shaft 17 is provided on the shoulder 46B. In the first tapered roller bearing 50, the outer circumference is supported by the first through hole 46A, and the lower surface is supported by the shoulder 46B.

The first tapered roller bearing 50 is a tapered roller bearing including a first outer ring 50A arranged on the inner circumferential surface of the first through hole 46A of the case 15, a first inner ring 50B coupled to the drive shaft 17, a plurality of first tapered rollers 50C arranged between the first outer ring 50A and the first inner ring 50B, and a first retainer 50D retaining the plurality of first tapered rollers 50C. The first outer ring 50A is supported by the first through hole 46A and the shoulder 46B of the case 15. Accordingly, the first tapered roller bearing 50 is supported by the case 15. The rotational axis of the first tapered roller 50C is inclined so as to approach the drive shaft 17 from the upper end (one end) of the drive shaft 17 toward the lower end (the other end) thereof.

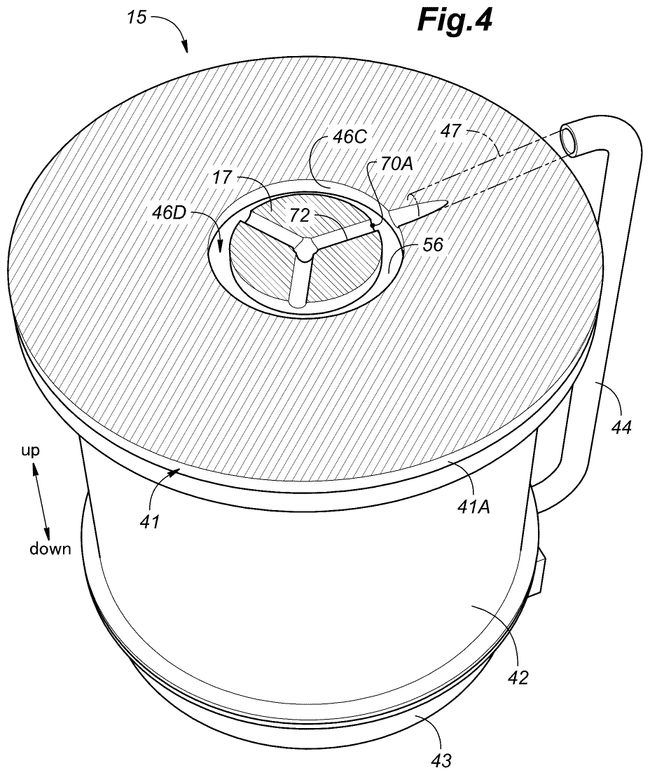

FIG. 4 is a perspective cross-sectional view of the upper lid 41. The oil through hole 47 is connected to the oil pipe 44 at the side surface 41A. The oil through hole 47 extends from the side surface 41A of the upper lid 41 to the second through hole 46C. The lubricating oil L flows through the oil pipe 44 and the oil through hole 47. As shown in FIG. 3, the first tapered roller bearing 50 is arranged on the oil through hole 47. The lubricating oil L flowing out from the oil pipe 44 to the oil through hole 47 lubricates the first tapered roller bearing 50.

As shown in FIGS. 3 and 4, the case body 42 is formed in a cylindrical shape extending in the axial direction X (up-and-down direction) around the outer circumference of the drive shaft 17. As shown in FIG. 3, the case body 42 includes a disc portion 51 at the upper end thereof that faces the lower surface of the upper lid 41, an upper flange 52 formed in the disc portion 51, a cylindrical portion 53 extending downward from the disc portion 51, a partition wall portion 54 formed in a plate shape and protruding radially inward from the cylindrical portion 53 with its surface facing up and down, and a lower flange 55 formed at the lower end of the cylindrical portion 53.

The electric motor 32 is accommodated in the space defined by the disc portion 51, the cylindrical portion 53, and the partition wall portion 54. Further, in the space inside the cylindrical portion 53, the transmission mechanism 33 is accommodated in the space below the partition wall portion 54.

The disc portion 51 includes a through hole extending vertically through the center thereof and through which the drive shaft 17 is inserted. The through hole is provided with an oil seal 56 that seals between the disc portion 51 and the drive shaft 17. The disc portion 51 is coupled to an upper bearing 57, which rotatably supports the upper end of the rotation shaft 31, at a radially outer side of the oil seal 56. The upper flange 52 is attached to the upper lid 41. The upper flange 52 and the upper lid 41 are preferably fastened together with a plurality of bolts.

The partition wall portion 54 includes the through hole at the radially inner end thereof, through which the drive shaft 17 and the rotation shaft 31 are inserted. The radially inner end of the partition wall portion 54 is coupled to a lower bearing 58 that rotatably supports the lower portion of the rotation shaft 31.

The upper bearing 57 and the lower bearing 58 are preferably bearings capable of supporting the radial load. The upper bearing 57 and the lower bearing 58 may be, for example, a ball bearing or a sliding bearing.

The lower lid 43 includes a flange 61 at the upper portion thereof that faces the lower flange 55, a lower cylindrical portion 63 extending downward from the flange 61 and including a bottom 62, a cylindrical wall portion 64 extending upward from the bottom 62 and surrounding the outer circumference of the lower end of the drive shaft 17, and an outlet hole 65 extending radially through the lower cylindrical portion 63. The lubricating oil L is stored in the lower cylindrical portion 63.

The flange 61 is attached to the lower flange 55. The flange 61 and the lower flange 55 are preferably fastened together with a plurality of bolts.

A second tapered roller bearing 66 (a second shaft support portion) that rotatably supports the drive shaft 17 is provided between the cylindrical wall portion 64 and the drive shaft 17. The cylindrical wall portion 64 is provided with a through hole 64A that faces the outlet hole 65. The outlet hole 65 is connected to the oil pipe 44.

The second tapered roller bearing 66 is a tapered roller bearing including a second outer ring 66A coupled to the upper end of the inner circumferential surface of the cylindrical wall portion 64, a second inner ring 66B coupled to the lower end (the other end) of the drive shaft 17, a plurality of second tapered rollers 66C arranged between the second outer ring 66A and the second inner ring 66B, and a second retainer 66D retaining the plurality of second tapered rollers 66C. The second inner ring 66B is supported from below by a retaining ring 67. The retaining ring 67 is attached to a groove formed on the outer circumferential surface of the lower end of the drive shaft 17.

The second tapered roller bearing 66 is supported by the cylindrical wall portion 64 that supports the second outer ring 66A, and the retaining ring 67 that supports the second inner ring 66B. The rotational axis of the second tapered roller 66C is inclined so as to approach the drive shaft 17 from the lower end (the other end) of the drive shaft 17 toward the upper end (one end) thereof.

The oil pipe 44 is a pipe connected to the oil through hole 47 of the upper lid 41 and the outlet hole 65 of the lower lid 43. The oil pipe 44 is provided with a pump 44A for pumping the lubricating oil L flowing through the oil pipe 44 from the outlet hole 65 of the lower lid 43 toward the oil through hole 47 of the upper lid 41, and a heat exchanger 44B for cooling the lubricating oil L.

The drive shaft 17 is inserted inside the rotation shaft 31 formed in a hollow cylindrical shape, and is arranged coaxially with the rotation shaft 31. There is a gap between the drive shaft 17 and the rotation shaft 31, and the drive shaft 17 and the rotation shaft 31 are spaced apart from each other. The drive shaft 17 includes the rotor 16 (not shown in FIG. 3) fixed to the upper end (one end) side thereof and is connected to the transmission mechanism 33 (a planetary carrier 83 which will be described later) at the lower end (the other end) thereof.

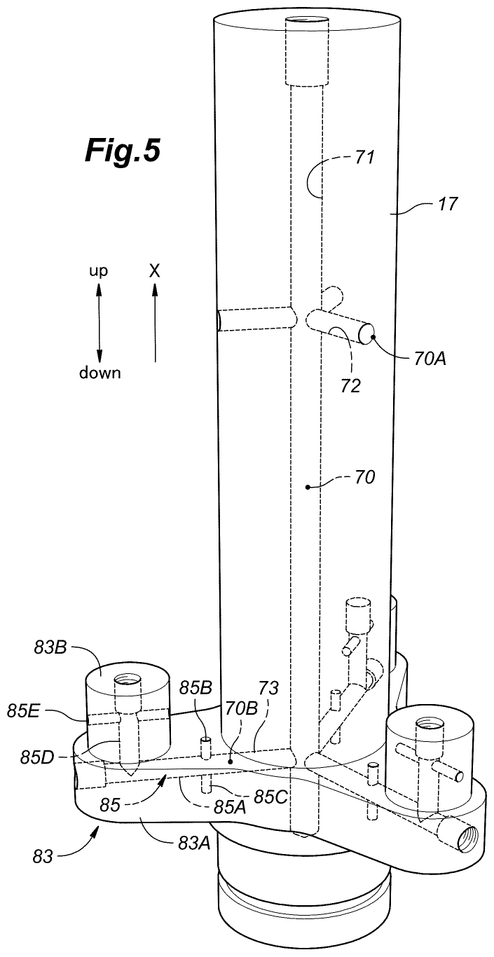

FIG. 5 is a perspective view of the drive shaft 17. The drive shaft 17 is provided with an internal passage 70 through which the lubricating oil L flows. The internal passage 70 includes an axial through hole 71 extending downward from the upper end of the drive shaft 17 along the central axis of the drive shaft 17, and three first radial through holes 72 and three second radial through holes 73 extending radially outward from the axial through hole 71.

As shown in FIG. 3, the axial through hole 71 is provided with a cap 71A at the upper end thereof. The cap 71A seals the upper end of the axial through hole 71. The positions of the three first radial through holes 72 in the axial direction X (up-and-down direction) are substantially the same as the position of the second through hole 46C of the through hole 46. As shown in FIG. 5, each of the three first radial through holes 72 extends radially from the axial through hole 71.

As shown in FIG. 5, each of the three second radial through holes 73 extends radially from the axial through hole 71. As shown in FIG. 3, each of the three second radial through holes 73 is connected to the axial through hole 71 and the transmission mechanism 33 (the planetary carrier 83, which will be described later).

The end (more specifically, the outer end in the radial direction of the axial through hole 71) of each of the three first radial through holes 72 constitutes an inlet 70A of the internal passage 70. The end (more specifically, the outer end in the radial direction of the axial through hole 71) of each of the three second radial through holes 73 constitutes an outlet 70B of the internal passage 70.

As shown in FIG. 3, the electric motor 32 includes the rotation shaft 31, a rotor 76 formed integrally with the rotation shaft 31, and a stator 77 that faces the rotor 76 at an interval on the outer circumference of the rotor 76.

The rotation shaft 31 is formed in a hollow cylindrical shape extending in the axial direction X, and the lower end thereof is coupled to the transmission mechanism 33. The upper end of the rotation shaft 31 is rotatably supported by the upper bearing 57, and the lower end of the rotation shaft 31 is rotatably supported by the lower bearing 58. The rotation shaft 31 is arranged between the first tapered roller bearing 50 and the second tapered roller bearing 66 in the axial direction X.

The rotor 76 includes a cylindrical rotor core 76A extending in the axial direction X, and a plurality of permanent magnets 76B fixed to the outer circumference of the rotor core 76A. The inner circumferential surface of the rotor core 76A is coupled to the outer circumferential surface of the rotation shaft 31.

The stator 77 is fixed to the inner circumference side of the cylindrical portion 53 and includes a plurality of coils (not shown). The magnetic force of the plurality of permanent magnets 76B of the rotor 76 and the magnetic force of the plurality of coils of the stator 77 generate the output torque that rotates the rotor 76 and the rotation shaft 31 about the axis of the rotation shaft 31.

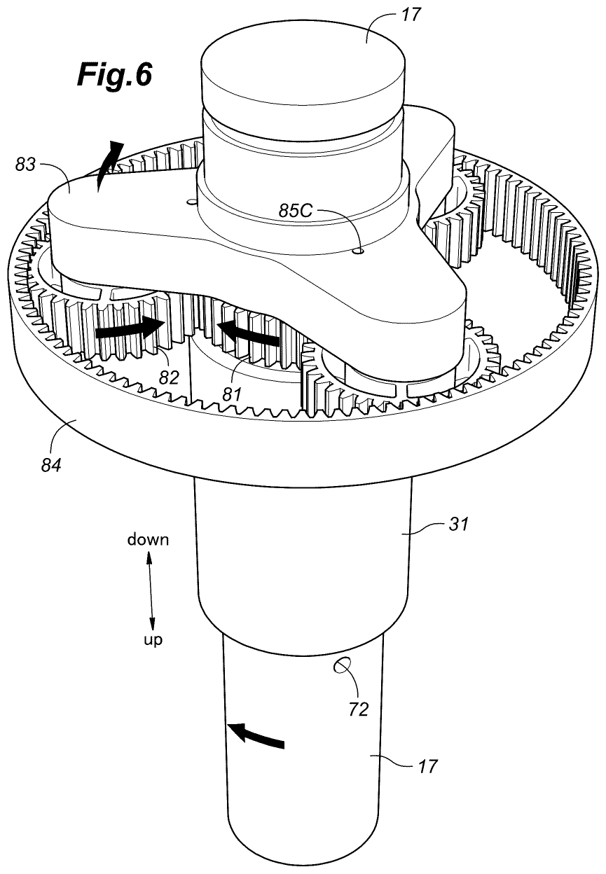

FIG. 6 is a perspective view of the transmission mechanism 33. As shown in FIG. 6, the transmission mechanism 33 is a planetary gear mechanism that includes the sun gear 81 provided on the outer circumference of the rotation shaft 31, three planetary gears 82 meshed with the sun gear 81, a planetary carrier 83 rotatably supporting the three planetary gears 82, and a ring gear 84 meshed with the three planetary gears 82. There is no limitation on the number of planetary gears 82. For example, the number of planetary gears 82 may be four.

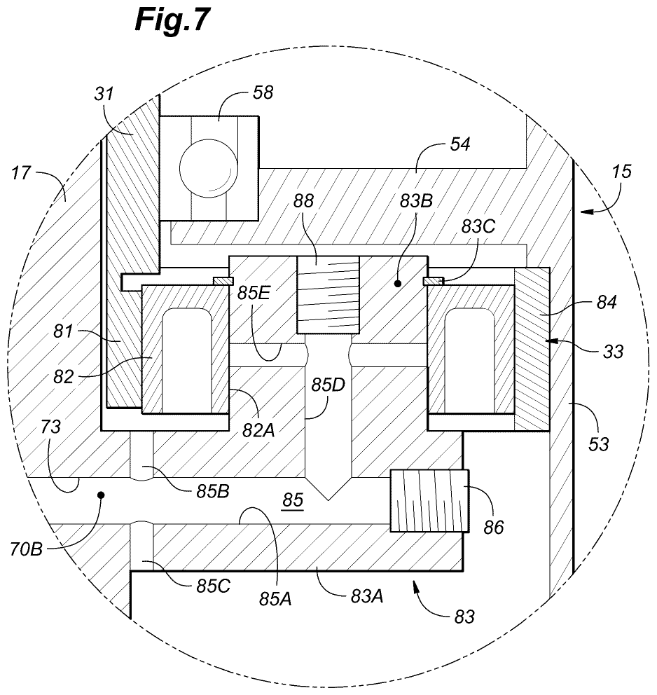

FIG. 7 is a cross-sectional view of the transmission mechanism 33. As shown in FIG. 7, the sun gear 81 is integrally formed with the lower end of the rotation shaft 31. The sun gear 81 is a spur gear that is coaxial with the rotation shaft 31. Each planetary gear 82 is a spur gear. Each planetary gear 82 includes a through hole 82A coaxial with the rotational axis. As shown in FIG. 6, the ring gear 84 is arranged coaxially with the drive shaft 17, the rotation shaft 31, and the sun gear 81. As shown in FIG. 7, the ring gear 84 is coupled to the inner surface of the cylindrical portion 53 of the case 15.

As shown in FIGS. 5 and 7, the planetary carrier 83 is coupled to the outer circumference of the drive shaft 17. The planetary carrier 83 includes three radially enlarged plate portions 83A extending radially outward from the drive shaft 17, a shaft 83B inserted from each of the three radially enlarged plate portions 83A into the through hole 82A (see FIG. 7) of the planetary gear 82, and a retaining ring 83C (see FIG. 7) that suppresses disengagement of the planetary gear 82 from the planetary carrier 83, and is formed integrally with the drive shaft 17. The shaft 83B rotatably supports the planetary gear 82. An oil passage 85 is formed inside the radially enlarged plate portion 83A and the shaft 83B. The retaining ring 83C is attached to a groove formed on the outer circumferential surface of the upper end of the shaft 83B, and abuts against the upper end of the planetary gear 82. The planetary gear 82 is arranged between the retaining ring 83C and the radially enlarged plate portion 83A. This suppresses disengagement of the planetary gear 82 from the planetary carrier 83.

The oil passage 85 includes a radial through hole 85A extending radially outward from the radially inner end of the radially enlarged plate portion 83A, a first oil supply hole 85B extending upward from the radial through hole 85A, a second oil supply hole 85C extending downward from the radial through hole 85A, an axial through hole 85D extending upward from the radial through hole 85A to the upper end of the shaft 83B, and a third oil supply hole 85E extending radially in the shaft 83B from the axial through hole 85D to the outer circumferential surface of the shaft 83B.

The radial through hole 85A is formed integrally with the second radial through hole 73 of the internal passage 70 of the drive shaft 17. The radial through hole 85A is connected to the outlet 70B of the internal passage 70 at the radially inner end of the planetary carrier 83, and is provided with a cap 86 (see FIG. 7) at the radially outer end thereof. The cap 86 seals the radial through hole 85A.

As shown in FIG. 7, the first oil supply hole 85B extends upward from the radial through hole 85A toward the portion where the sun gear 81 and the planetary gear 82 mesh with each other. The upper end of the first oil supply hole 85B faces the portion where the sun gear 81 and the planetary gear 82 mesh with each other.

The second oil supply hole 85C extends downward from the radial through hole 85A toward the upper surface of the second tapered roller bearing 66. As shown in FIG. 3, the lower end of the second oil supply hole 85C faces the upper surface of the second tapered roller bearing 66. As shown in FIG. 7, a cap 88 is provided at the outer end of the axial through hole 85D. The cap 88 seals the axial through hole 85D.

### Transmission of Driving Force of the Electric Drive Device 10

As shown in FIG. 6, when the rotation shaft 31 is rotated by the electric motor 32, the sun gear 81 provided on the outer circumference of the rotation shaft 31 rotates. As the sun gear 81 rotates, the three planetary gears 82 meshed with the sun gear 81 rotate about the axes and revolve around the outer circumference of the sun gear 81. Accordingly, the planetary carrier 83 rotates together with the drive shaft 17 about the axis of the drive shaft 17. Accordingly, the output torque of the rotation shaft 31 is decelerated and transmitted to the drive shaft 17. The drive shaft 17 rotates together with the rotor 16 and applies the ascending and descending forces to the aircraft 1.

### Circulation of the Lubricating Oil L

The space that is provided in the electric drive device 10 and through which the lubricating oil L flows is referred to as “lubricating oil passage 87.” As shown in FIG. 3, the lubricating oil passage 87 includes a space 87A defined by the cylindrical portion 53, the partition wall portion 54, the rotation shaft 31, and the lower lid 43, an internal space 87B of the oil pipe 44, a space 87C including the oil through hole 47 and the second through hole 46C of the upper lid 41, the internal passage 70 of the drive shaft 17, and the oil passage 85 of the planetary carrier 83.

The lubricating oil L is stored in the space 87A (lower cylindrical portion 63). In FIG. 3, the oil level OL1 is the oil level of the lubricating oil L when the drive shaft 17 is not rotating. The pump 44A of the oil pipe 44 pumps the lubricating oil L flowing through the oil pipe 44 from the outlet hole 65 of the lower lid 43 toward the oil through hole 47 of the upper lid 41. Accordingly, the lubricating oil L stored in the space 87A (lower cylindrical portion 63) flows into the oil pipe 44 from the outlet hole 65 of the lower lid 43, and the lubricating oil L flows out from the oil pipe 44 to the oil through hole 47. The lubricating oil L flows through the oil through hole 47.

The first tapered roller bearing 50 is arranged on the oil through hole 47. The lubricating oil L infiltrates the first tapered roller bearing 50 through the oil through hole 47. The lubricating oil L flowing out from the oil through hole 47 flows into the second through hole 46C. As shown in FIG. 4, the lubricating oil L flowing out from the oil through hole 47 is stored in the space 46D defined by the second through hole 46C, the oil seal 56, and the drive shaft 17. Then, the lubricating oil L flows from the space 46D into the inlet 70A of the internal passage 70.

As shown in FIG. 3, the lubricating oil L that has flowed into the internal passage 70 flows through the internal passage 70 and flows into the oil passage 85 from the outlet 70B. As shown in FIG. 7, the lubricating oil L flowing through the oil passage 85 flows out from the first oil supply hole 85B, the second oil supply hole 85C, and the third oil supply hole 85E.

The lubricating oil L flowing out from the first oil supply hole 85B flows toward the portion where the sun gear 81 and the planetary gear 82 mesh with each other. Accordingly, the meshing portion between the sun gear 81 and the planetary gear 82 is lubricated. The lubricating oil L is then deposited on the planetary gear 82. Further, the lubricating oil L is fed to the planetary gear 82 and deposited on the ring gear 84. Accordingly, lubrication is provided between the planetary gear 82 and the ring gear 84.

The lubricating oil L flowing out from the third oil supply hole 85E flows into a gap between the outer circumferential surface of the shaft 83B of the planetary carrier 83 and the through hole 82A of the planetary gear 82. As described above, the lubricating oil L flowing out from the first oil supply hole 85B and the third oil supply hole 85E lubricates the transmission mechanism 33 and drips onto the bottom 62 of the lower cylindrical portion 63. The dripped lubricating oil L is stored in the space 87A (lower cylindrical portion 63).

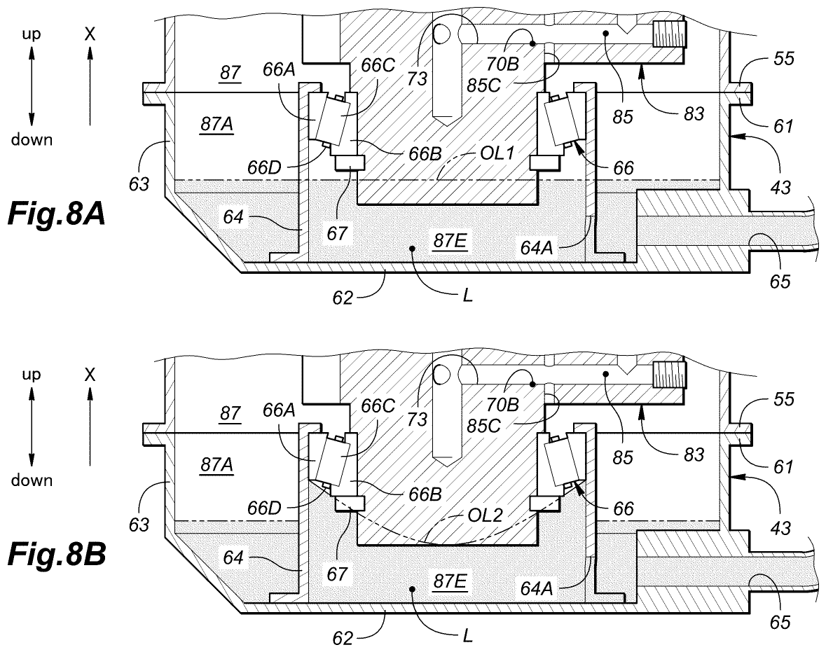

FIG. 8A is a cross-sectional view of the bottom 62 of the case 15 when the drive shaft 17 is not rotating. As shown in FIG. 8A, the lubricating oil L flowing out of the second oil supply hole 85C flows into the second tapered roller bearing 66 from the upper surface of the second tapered roller bearing 66, and lubricates the second tapered roller bearing 66. The lubricating oil L drips from the second tapered roller bearing 66 and is stored at the bottom 62 of the lower cylindrical portion 63.

The second tapered roller bearing 66 is arranged in the space 87A. In the space 87A, a space defined by the bottom 62 of the case 15 (lower lid 43), the drive shaft 17, the second tapered roller bearing 66, and the cylindrical wall portion 64 is referred to as “oil storage space 87E.” The lubricating oil L is stored in the oil storage space 87E. As shown in FIG. 8A, when the drive shaft 17 is not rotating, the oil level OL1 of the lubricating oil L in the oil storage space 87E is lower than the lower end of the second tapered roller bearing 66, and the lower end (the other end) of the drive shaft 17 is immersed in the lubricating oil L.

FIG. 8B is a cross-sectional view of the bottom 62 of the case 15 when the drive shaft 17 is rotating. As shown in FIG. 8B, when the drive shaft 17 rotates, the lubricating oil L stored in the oil storage space 87E rotates together with the drive shaft 17. Then, due to the centrifugal force of the lubricating oil L, the oil level of the lubricating oil L becomes higher on the outer circumference side of the oil storage space 87E. The oil level OL2 in FIG. 8B is an example of the oil level when the drive shaft 17 is rotating. If the drive shaft 17 rotates fast enough, the lubricating oil L reaches the second tapered roller bearing 66, as shown by the oil level OL2. The second tapered roller bearing 66 is lubricated by the lubricating oil L that reaches the second tapered roller bearing 66.

Next, the effects of the electric drive device 10 will be described.

As shown in FIG. 3, the drive shaft 17 is rotatably supported by the first tapered roller bearing 50 and the second tapered roller bearing 66. The first tapered roller bearing 50 is arranged closer to the upper end (one end) side of the drive shaft 17 than the rotation shaft 31. The second tapered roller bearing 66 is arranged closer to the lower end (the other end) of the drive shaft 17 than the rotation shaft 31. Accordingly, the drive shaft 17 is rotatably supported by the first tapered roller bearing 50 and the second tapered roller bearing 66 which are spaced apart from each other by a length longer than the length of the rotation shaft 31 in the axial direction X. Accordingly, the drive shaft 17 is firmly supported. Further, the drive shaft 17 is inserted inside the rotation shaft 31, thereby the electric drive device 10 is made compact. Accordingly, the electric drive device 10 can achieve both firm support of the drive shaft 17 and compactness.

The transmission mechanism 33 is connected to the rotation shaft 31 and the drive shaft 17 at the lower end (the other end) side of the drive shaft 17. The rotor 16 is connected to the upper end side of the drive shaft 17. Accordingly, the drive shaft 17 receives a greater radial load on the lower end side than on the upper end side. The drive shaft 17 is connected to the transmission mechanism 33 at the lower end side thereof, and the lower end side of the drive shaft 17 is supported by the transmission mechanism 33. Accordingly, it is possible to more reliably resist the radial load of the drive shaft 17.

The transmission mechanism 33 is the planetary gear mechanism, and the planetary carrier 83 is connected to the drive shaft 17. Since the transmission mechanism 33 is the planetary gear mechanism, the length of the transmission mechanism 33 in the axial direction X can be shortened. Accordingly, the electric drive device 10 can be made compact. Further, the drive shaft 17 is connected to the planetary carrier 83 and is supported by the planetary carrier 83. Accordingly, the drive shaft 17 can be supported more firmly.

The first tapered roller bearing 50 and the second tapered roller bearing 66 are arranged on the lubricating oil passage 87. Accordingly, the first tapered roller bearing 50 and the second tapered roller bearing 66 can be lubricated by the lubricating oil L flowing through the lubricating oil passage 87.

The internal passage 70 is a portion of the lubricating oil passage 87. Since the internal passage 70 is formed in the drive shaft 17, the lubricating oil passage 87 can be made compact.

In the oil storage space 87E, the oil level OL1 of the lubricating oil L is lower than the lower end of the second tapered roller bearing 66, and the lower end (the other end) of the drive shaft 17 is immersed in the lubricating oil L. If the lubricating oil L is supplied to the second tapered roller bearing 66 in excess, the rotation of the second tapered roller bearing 66 may be restrained due to the viscosity of the lubricating oil L. In the oil storage space 87E, the oil level OL1 of the lubricating oil L is lower than the lower end of the second tapered roller bearing 66, so that the second tapered roller bearing 66 is not immersed in the lubricating oil L. Accordingly, it is possible to prevent the lubricating oil L from being excessively supplied to the second tapered roller bearing 66.

Further, in the oil storage space 87E, the lower end (the other end) of the drive shaft 17 is immersed in the lubricating oil L. When the drive shaft 17 rotates, the lubricating oil L stored in the oil storage space 87E rotates together with the drive shaft 17. As shown by the oil level OL2 in FIG. 8B, due to the centrifugal force of the lubricating oil L, the oil level of the lubricating oil L becomes higher on the outer circumference side of the oil storage space 87E. If the drive shaft 17 rotates fast enough, the lubricating oil L reaches the second tapered roller bearing 66 on the outer circumference side of the oil storage space 87E. Accordingly, the second tapered roller bearing 66 is lubricated. In this way, the lubricating oil L lubricates the second tapered roller bearing 66 while preventing the excessive supply of t he lubricating oil L to the second tapered roller bearing 66. Accordingly, the second tapered roller bearing 66 can be properly lubricated.

The first tapered roller bearing 50 can support the radial load and the axial load of the drive shaft 17. Further, the first tapered roller bearing 50 is arranged closer to the upper end (one end) side of the drive shaft 17 than the second tapered roller bearing 66, and the rotational axis of the first tapered roller 50C is inclined so as to approach the drive shaft 17 from the upper end of the drive shaft 17 toward the lower end thereof. Thereby, the action point of the first tapered roller bearing 50 is arranged closer to the upper end (one end) side of the drive shaft 17 than the rotation shaft 31. Thus, the first tapered roller bearing 50 can more firmly support the radial load of the drive shaft 17 than when the rotational axis of the first tapered roller 50C is inclined so as to recede from the drive shaft 17 from the upper end (one end) of the drive shaft 17 toward the lower end (the other end) thereof. Accordingly, the drive shaft 17 can be firmly supported by the first tapered roller bearing 50.

The second tapered roller bearing 66 can support the radial load and the axial load of the drive shaft 17. Further, the second tapered roller bearing 66 is arranged closer to the lower end (other end) side of the drive shaft 17 than the first tapered roller bearing 50, and the rotational axis of the second tapered roller 66C is inclined so as to approach the drive shaft 17 from the lower end of the drive shaft 17 toward the upper end thereof. Thereby, the action point of the second tapered roller bearing 66 is arranged closer to the lower end (the other end) side of the drive shaft 17 than the rotation shaft 31. Accordingly, the second tapered roller bearing 66 can more firmly support the radial load of the drive shaft 17 than when the rotational axis of the second tapered roller 66C is inclined so as to recede from the drive shaft 17 from the lower end (the other end) of the drive shaft 17 toward the upper end (one end) thereof. Accordingly, the drive shaft 17 can be firmly supported by the second tapered roller bearing 66.

### Second Embodiment

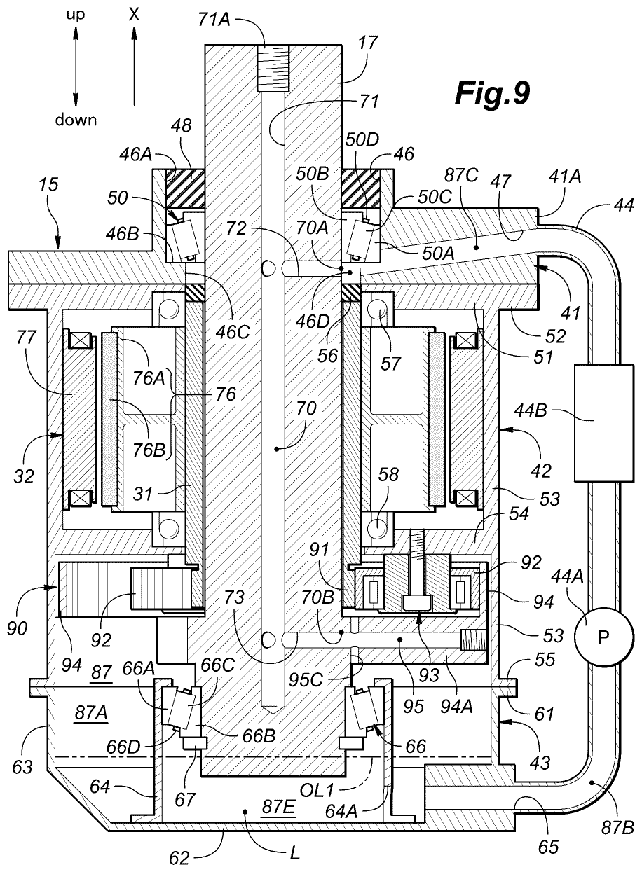

FIG. 9 is a schematic cross-sectional view of the electric drive device 10 according to the second embodiment of the present invention. As shown in FIG. 9, the electric drive device 10 according to the second embodiment includes a transmission mechanism 90 that has a different configuration from the transmission mechanism 33 of the electric drive device 10 according to the first embodiment. In the following description according to the second embodiment, components corresponding to those of the first embodiment are denoted with like numerals without necessarily repeating the description of such components.

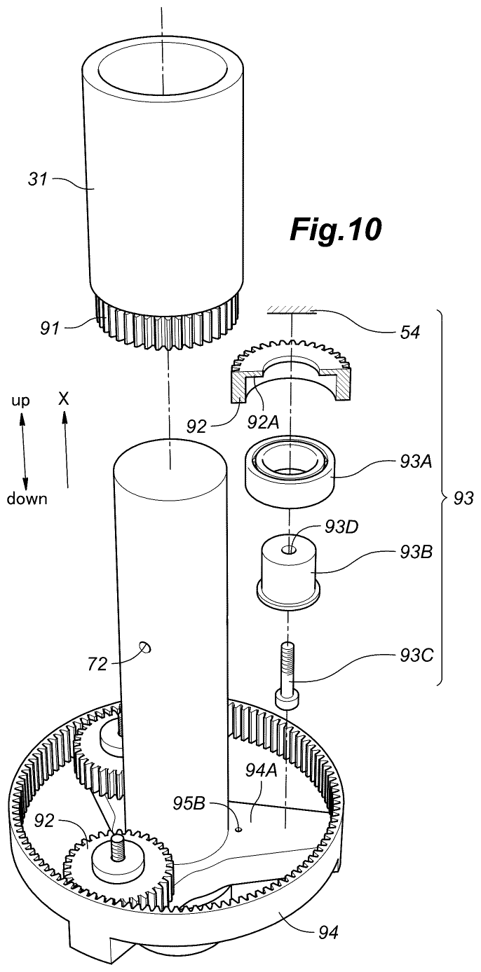

FIG. 10 is an exploded perspective view of the transmission mechanism 90. As shown in FIG. 10, the transmission mechanism 90 is a planetary gear mechanism that includes a sun gear 91 provided on the outer circumference of the rotation shaft 31, three planetary gears 92 meshed with the sun gear 91, a planetary carrier 93 rotatably supporting the three planetary gears 92, and a ring gear 94 meshed with the three planetary gears 92.

The sun gear 91 is formed integrally with the lower end of the rotation shaft 31. The sun gear 91 is the spur gear that is coaxial with the rotation shaft 31.

Each planetary gear 92 is a spur gear. Each planetary gear 92 is formed in a cylindrical shape extending in the axial direction X, and includes an annular upper wall 92A extending radially inward at the upper end thereof.

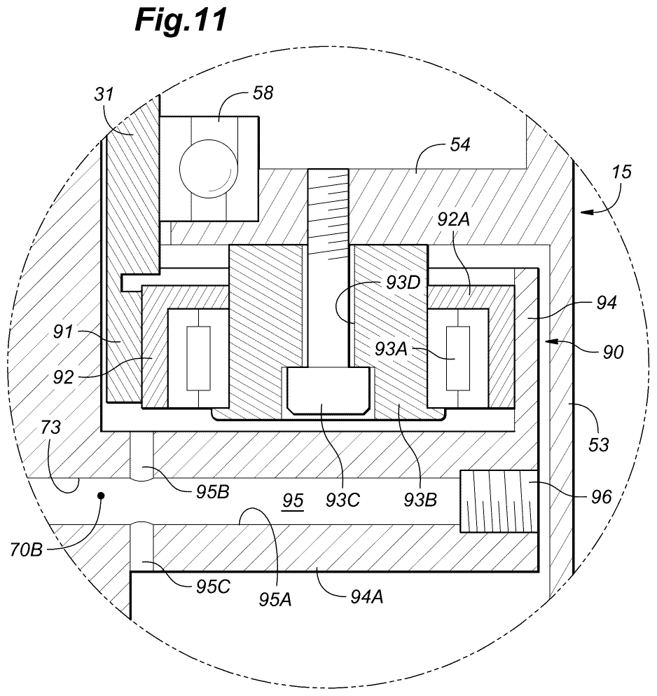

FIG. 11 is a cross-sectional view of the transmission mechanism 90. As shown in FIGS. 10 and 11, the planetary carrier 93 includes the partition wall portion 54 of the case 15, the bearing 93A arranged on the inner circumferential side of the planetary gear 92, the cylindrical shaft portion 93B arranged inside the bearing 93A, and the support member 93C that supports the planetary gear 92, the bearing 93A, and the cylindrical shaft portion 93B. The bearing 93A, the cylindrical shaft portion 93B, and the support member 93C are arranged coaxially.

The bearing 93A is arranged below the upper wall 92A of the planetary gear 92. The bearing 93A is preferably a bearing capable of supporting the radial load. The bearing 93A may be a ball bearing or a sliding bearing.

The cylindrical shaft portion 93B includes the through hole 93D extending in the rotational axis direction (axial direction X). The support member 93C extends in the rotational axis direction (axial direction X). The support member 93C is inserted through the through hole 93D of the cylindrical shaft portion 93B and is fixed to the partition wall portion 54 at the upper end thereof. Thereby, the cylindrical shaft portion 93B is supported by the support member 93C. The cylindrical shaft portion 93B rotatably supports the planetary gear 92 together with the bearing 93A. Accordingly, the planetary gear 92 is rotatably supported by the support member 93C via the bearing 93A and the cylindrical shaft portion 93B. The support member 93C may be a bolt fixed to the partition wall portion 54.

As shown in FIGS. 3 and 10, the ring gear 94 is arranged coaxially with the drive shaft 17, the rotation shaft 31, and the sun gear 91. As shown in FIG. 10, the ring gear 94 is integrally joined to three radially enlarged plate portions 94A that extend radially outward from the outer circumference of the drive shaft 17. As shown in FIG. 11, an oil passage 95 is formed inside the radially enlarged plate portion 94A.

The oil passage 95 includes a radial through hole 95A extending radially outward from the radially inner end of the radially enlarged plate portion 94A, a first oil supply hole 95B extending upward from the radial through hole 95A, and a second oil supply hole 95C extending downward from the radial through hole 95A.

The radial through hole 95A is formed integrally with the second radial through hole 73 of the drive shaft 17. The radial through hole 95A is connected to the outlet 70B of the internal passage 70 at the radially inner end thereof, and is provided with a cap 96 at the radially outer end thereof. The cap 96 seals the radial through hole 95A.

The first oil supply hole 95B extends upward from the radial through hole 95A toward the portion where the sun gear 91 and the planetary gear 92 mesh with each other. The upper end of the first oil supply hole 95B faces the portion where the sun gear 91 and the planetary gear 92 mesh with each other. The second oil supply hole 95C extends downward from the radial through hole 95A toward the upper surface of the second tapered roller bearing 66. As shown in FIG. 9, the lower end of the second oil supply hole 95C faces the upper surface of the second tapered roller bearing 66.

The lubricating oil L that has flowed into the internal passage 70 flows through the internal passage 70 and flows into the oil passage 95 from the outlet 70B of the internal passage 70. The lubricating oil L flowing through the oil passage 95 flows out from the first oil supply hole 95B and the second oil supply hole 95C.

The lubricating oil L flowing out from the first oil supply hole 95B flows toward the portion where the sun gear 91 and the planetary gear 92 mesh with each other. Accordingly, the meshing portion between the sun gear 91 and the planetary gear 92 is lubricated. The lubricating oil L is then deposited on the planetary gear 92. Further, the lubricating oil L is fed to the planetary gear 92 and deposited on the ring gear 94. Accordingly, lubrication is provided between the planetary gear 92 and the ring gear 94.

The lubricating oil L flowing out from the second oil supply hole 95C flows into the second tapered roller bearing 66 from the upper surface of the second tapered roller bearing 66, and lubricates the second tapered roller bearing 66. The lubricating oil L dripped from the second tapered roller bearing 66 is stored at the bottom 62 of the lower cylindrical portion 63 of the space 87A.

### Transmission of Driving Force of the Electric Drive Device 10

As shown in FIG. 10, when the rotation shaft 31 is rotated by the electric motor 32, the sun gear 91 provided on the outer circumference of the rotation shaft 31 rotates. As the sun gear 91 rotates, the three planetary gears 92 meshed with the sun gear 91 rotate about their axes. The planetary gear 92 is supported by the planetary carrier 93 that is fixed to the partition wall portion 54. Accordingly, the planetary gear 92 does not revolve around the outer circumference of the sun gear 91. As shown in FIG. 11, the ring gear 94 meshed with the sun gear 91 is spaced apart from the case 15. As shown in FIG. 10, the output torque of the sun gear 91 (rotation shaft 31) is transmitted to the ring gear 94 via the planetary gear 92, and the ring gear 94 rotates together with the drive shaft 17. Accordingly, the output torque of the rotation shaft 31 is decelerated and transmitted to the drive shaft 17. The drive shaft 17 rotates together with the rotor 16 and applies the ascending and descending forces to the aircraft 1.

The transmission mechanism 90 is the planetary gear mechanism, and the ring gear 94 is connected to the drive shaft 17. Since the transmission mechanism 90 is a planetary gear mechanism, the length of the transmission mechanism 90 in the axial direction X can be shortened. Accordingly, the electric drive device 10 can be made compact. Further, the drive shaft 17 is connected to the ring gear 94 and is supported by the ring gear 94. Accordingly, the drive shaft 17 can be supported more firmly.

The present embodiment is not limited to the above configuration and can be widely modified and implemented. For example, in the electric drive device 10 according to the first embodiment, the transmission mechanism 33 may be arranged closer to the upper end (one end) side of the drive shaft 17. The transmission mechanism 33 according to the first embodiment and the transmission mechanism 90 according to the second embodiment may not necessarily be a planetary gear mechanism. The electric drive device 10 according to the first embodiment and the electric drive device 10 according to the second embodiment need not be provided with the lubricating oil passage 87. The lubricating oil passage 87 may not include the internal passage 70 formed in the drive shaft 17. The electric drive device 10 according to the first embodiment and the electric drive device 10 according to the second embodiment need not be provided with the cylindrical wall portion 64. The first tapered roller bearing 50 and the second tapered roller bearing 66 may be bearings other than the tapered roller bearing.

The above embodiments may also be described as follows.

One aspect of the present embodiment provides an electric drive device 10 comprising: an electric motor 32 including a rotation shaft 31; a drive shaft 17 having a rotor 16 fixed to an upper end (one end) side thereof; a transmission mechanism 33 connected to the rotation shaft 31 and the drive shaft 17 and configured to transmit an output torque of the electric motor 32 from the rotation shaft 31 to the drive shaft 17; a case 15; and a first tapered roller bearing 50 (a first shaft support portion) and a second tapered roller bearing 66 (a second shaft support portion) rotatably supporting the drive shaft 17 and supported by the case 15 at positions spaced apart from each other in an axial direction X of the drive shaft 17. The rotation shaft 31 is formed in a hollow tubular shape extending in the axial direction X, and is arranged between the first tapered roller bearing 50 and the second tapered roller bearing 66 in the axial direction X, the drive shaft 17 is inserted inside the rotation shaft 31 and is arranged coaxially with the rotation shaft 31, and the first tapered roller bearing 50 is arranged closer to the upper end (one end) side of the drive shaft 17 than the rotation shaft 31, and the second tapered roller bearing 66 is arranged closer to a lower end (the other end) side of the drive shaft 17 than the rotation shaft 31.

According to this aspect, the drive shaft 17 is rotatably supported by the first tapered roller bearing 50 and the second tapered roller bearing 66 which are spaced apart from each other by a length longer than the length of the rotation shaft 31 in the axial direction X. Accordingly, the drive shaft 17 is firmly supported. Further, the drive shaft 17 is inserted inside the rotation shaft 31, thereby the electric drive device 10 is made compact. Accordingly, the electric drive device 10 can achieve both firm support of the drive shaft 17 and compactness.

In one embodiment, the transmission mechanism 33 is connected to the rotation shaft 31 and the drive shaft 17 at the lower end (the other end) side of the drive shaft 17.

According to this aspect, the rotor 16 is connected to the upper end side of the drive shaft 17. Accordingly, the drive shaft 17 receives a greater radial load on the lower end side than on the upper end side. The drive shaft 17 is connected to the transmission mechanism 33 at the lower end side thereof, and the lower end side of the drive shaft 17 is supported by the transmission mechanism 33. Accordingly, it is possible to more reliably resist the radial load of the drive shaft 17.

In one embodiment, the transmission mechanism 33 is a planetary gear mechanism including a sun gear 81 arranged on an outer circumference of the rotation shaft 31, a plurality of planetary gears 82 meshed with the sun gear 81, a planetary carrier 83 rotatably supporting the plurality of planetary gears 82, and a ring gear 84 meshed with the plurality of planetary gears 82, and the planetary carrier 83 is connected to the drive shaft 17.

According to this aspect, since the transmission mechanism 33 is the planetary gear mechanism, the length of the transmission mechanism 33 in the axial direction X can be shortened. Accordingly, the electric drive device 10 can be made compact. Further, the drive shaft 17 is connected to the planetary carrier 83 and is supported by the planetary carrier 83. Accordingly, the drive shaft 17 can be supported more firmly.

In one embodiment, the transmission mechanism 90 is a planetary gear mechanism including: a sun gear 91 arranged on an outer circumference of the rotation shaft 31; a plurality of planetary gears 92 meshed with the sun gear 91; a planetary carrier 93 rotatably supporting the plurality of planetary gears 92; and a ring gear 94 meshed with the plurality of planetary gears 92, and the ring gear 94 is connected to the drive shaft 17.

According to this aspect, the transmission mechanism 90 is the planetary gear mechanism, and the ring gear 94 is connected to the drive shaft 17. Since the transmission mechanism 90 is a planetary gear mechanism, the length of the transmission mechanism 90 in the axial direction X can be shortened. Accordingly, the electric drive device 10 can be made compact. Further, the drive shaft 17 is connected to the ring gear 94 and is supported by the ring gear 94. Accordingly, the drive shaft 17 can be supported more firmly.

In one embodiment, the electric drive device 10 further comprises: a lubricating oil passage 87 that is provided in the case 15 and through which a lubricating oil L flows; and a pump 44A provided in the lubricating oil passage 87 and configured to pump the lubricating oil L, and the first tapered roller bearing 50 and the second tapered roller bearing 66 are arranged on the lubricating oil passage 87.

According to this aspect, the first tapered roller bearing 50 and the second tapered roller bearing 66 can be lubricated by the lubricating oil L flowing through the lubricating oil passage 87.

In one embodiment, the lubricating oil passage 87 includes an internal passage 70 formed in the drive shaft 17, and the internal passage 70 includes an inlet 70A formed closer to the first tapered roller bearing 50 of the drive shaft 17 and an outlet 70B formed closer to the second tapered roller bearing 66 of the drive shaft 17.

According to this aspect, the internal passage 70 is a portion of the lubricating oil passage 87. Since the internal passage 70 is formed in the drive shaft 17, the lubricating oil passage 87 can be made compact.

In one embodiment, the electric drive device 10 further comprises a cylindrical wall portion 64 extending from a bottom 62 of the case 15 toward the upper end (one end) side of the drive shaft 17 and surrounding an outer circumference of the lower end (other end) of the drive shaft 17. The second tapered roller bearing 66 is arranged between the cylindrical wall portion 64 and the drive shaft 17, the lubricating oil L is stored in an oil storage space 87E defined by the bottom 62 of the case 15, the drive shaft 17, the second tapered roller bearing 66, and the cylindrical wall portion 64, and in the oil storage space 87E, an oil level of the lubricating oil L is lower than a lower end of the second tapered roller bearing 66, and the lower end (the other end) of the drive shaft 17 is immersed in the lubricating oil L.

According to this aspect, in the oil storage space 87E, the oil level OL1 of the lubricating oil L is lower than the lower end of the second tapered roller bearing 66, so that the second tapered roller bearing 66 is not immersed in the lubricating oil L. Accordingly, it is possible to prevent the lubricating oil L from being excessively supplied to the second tapered roller bearing 66. In the oil storage space 87E, the lower end (the other end) of the drive shaft 17 is immersed in the lubricating oil L. When the drive shaft 17 rotates, the lubricating oil L stored in the oil storage space 87E rotates together with the drive shaft 17. Then, due to the centrifugal force of the lubricating oil L, the oil level of the lubricating oil L becomes higher on the outer circumference side of the oil storage space 87E. If the drive shaft 17 rotates fast enough, the lubricating oil L reaches the second tapered roller bearing 66 on the outer circumference side of the oil storage space 87E. Accordingly, the second tapered roller bearing 66 is lubricated. In this way, the lubricating oil L lubricates the second tapered roller bearing 66 while preventing the excessive supply of the lubricating oil L to the second tapered roller bearing 66. Accordingly, the second tapered roller bearing 66 can be properly lubricated.

In one embodiment, the first shaft support portion is arranged closer to the upper end (one end) side of the drive shaft 17 than the second tapered roller bearing 66, and is the first tapered roller bearing 50 including a first outer ring 50A supported by the case 15, a first inner ring 50B coupled to the drive shaft 17, a plurality of first tapered rollers 50C arranged between the first outer ring 50A and the first inner ring 50B, and a first retainer 50D retaining the plurality of first tapered rollers 50C, and rotational axes of the plurality of first tapered rollers 50C are inclined so as to approach the drive shaft 17 from the upper end (one end) of the drive shaft 17 toward the lower end (the other end) thereof.

According to this aspect, the first tapered roller bearing 50 can support the radial load and the axial load of the drive shaft 17. Further, the first tapered roller bearing 50 is arranged closer to the upper end (one end) side of the drive shaft 17 than the second tapered roller bearing 66, and the rotational axis of the first tapered roller 50C is inclined so as to approach the drive shaft 17 from the upper end (one end) of the drive shaft 17 toward the lower end (the other end) thereof. Thereby, the action point of the first tapered roller bearing 50 is arranged closer to the upper end (one end) side of the drive shaft 17 than the rotation shaft 31. Thus, the first tapered roller bearing 50 can more firmly support the radial load of the drive shaft 17 than when the rotational axis of the first tapered roller 50C is inclined so as to recede from the drive shaft 17 from the upper end (one end) of the drive shaft 17 toward the lower end (the other end) thereof. Accordingly, the drive shaft 17 can be firmly supported by the first tapered roller bearing 50.

In one embodiment, the second shaft support portion is arranged closer to the lower end (the other end) side of the drive shaft 17 than the first tapered roller bearing 50, and is the second tapered roller bearing 66 including a second outer ring 66A supported by the case 15, a second inner ring 66B coupled to the lower end (the other end) of t he drive shaft 17, a plurality of second tapered rollers 66C arranged between the second outer ring 66A and the second inner ring 66B, and a second retainer 66D retaining the plurality of second tapered rollers 66C, and rotational axes of the plurality of second tapered rollers 66C are inclined so as to approach the drive shaft 17 from the lower end (the other end) of the drive shaft 17 toward the upper end (one end) thereof.

According to this aspect, the drive shaft 17 is supported by the second tapered roller bearing 66. The second tapered roller bearing 66 can support the radial load and the axial load of the drive shaft 17. Further, the second tapered roller bearing 66 is arranged closer to the lower end (other end) side of the drive shaft 17 than the first tapered roller bearing 50, and the rotational axis of the second tapered roller 66C is inclined so as to approach the drive shaft 17 from the lower end (the other end) of the drive shaft 17 toward the upper end (one end) thereof. Thereby, the action point of the second tapered roller bearing 66 is arranged closer to the lower end (the other end) side of the drive shaft 17 than the rotation shaft 31. Accordingly, the second tapered roller bearing 66 can more firmly support the radial load of the drive shaft 17 than when the rotational axis of the second tapered roller 66C is inclined so as to recede from the drive shaft 17 from the lower end (the other end) of the drive shaft 17 toward the upper end (one end) thereof. Accordingly, the drive shaft 17 can be firmly supported by the second tapered roller bearing 66.

1. An electric drive device comprising:
an electric motor including a rotation shaft;
a drive shaft having a rotor fixed to one end side thereof;
a transmission mechanism connected to the rotation shaft and the drive shaft and configured to transmit an output torque of the electric motor from the rotation shaft to the drive shaft;
a case; and
a first shaft support portion and a second shaft support portion rotatably supporting the drive shaft and supported by the case at positions spaced apart from each other in an axial direction of the drive shaft, wherein
the rotation shaft is formed in a hollow tubular shape extending in the axial direction, and is arranged between the first shaft support portion and the second shaft support portion in the axial direction,
the drive shaft is inserted inside the rotation shaft and is arranged coaxially with the rotation shaft, and
the first shaft support portion is arranged closer to the one end side of the drive shaft than the rotation shaft, and the second shaft support portion is arranged closer to the other end side of the drive shaft than the rotation shaft.

2. The electric drive device according to claim 1, wherein the transmission mechanism is connected to the rotation shaft and the drive shaft at the other end side of the drive shaft.

3. The electric drive device according to claim 1, wherein the transmission mechanism is a planetary gear mechanism including:
a sun gear arranged on an outer circumference of the rotation shaft;
a plurality of planetary gears meshed with the sun gear;
a planetary carrier rotatably supporting the plurality of planetary gears; and
a ring gear meshed with the plurality of planetary gears, and
the planetary carrier is connected to the drive shaft.

4. The electric drive device according to claim 1, wherein the transmission mechanism is a planetary gear mechanism including:
a sun gear arranged on an outer circumference of the rotation shaft;
a plurality of planetary gears meshed with the sun gear;
a planetary carrier rotatably supporting the plurality of planetary gears; and
a ring gear meshed with the plurality of planetary gears, and
the ring gear is connected to the drive shaft.

5. The electric drive device according to claim 1, further comprising:
a lubricating oil passage that is provided in the case and through which a lubricating oil flows; and
a pump provided in the lubricating oil passage and configured to pump the lubricating oil, wherein
the first shaft support portion and the second shaft support portion are arranged on the lubricating oil passage.

6. The electric drive device according to claim 5, wherein the lubricating oil passage includes an internal passage formed in the drive shaft, and
the internal passage includes an inlet formed closer to the first shaft support portion of the drive shaft and an outlet formed closer to the second shaft support portion of the drive shaft.

7. The electric drive device according to claim 5, further comprising a cylindrical wall portion extending from a bottom of the case toward the one end side of the drive shaft and surrounding an outer circumference of the other end of the drive shaft, wherein
the second shaft support portion is arranged between the cylindrical wall portion and the drive shaft,
the lubricating oil is stored in an oil storage space defined by the bottom of the case, the drive shaft, the second shaft support portion, and the cylindrical wall portion, and
in the oil storage space, an oil level of the lubricating oil is lower than a lower end of the second shaft support portion, and the other end of the drive shaft is immersed in the lubricating oil.

8. The electric drive device according to claim 1, wherein the first shaft support portion is a first tapered roller bearing arranged closer to the one end side of the drive shaft than the second shaft support portion, and including a first outer ring supported by the case, a first inner ring coupled to the drive shaft, a plurality of first tapered rollers arranged between the first outer ring and the first inner ring, and a first retainer retaining the plurality of first tapered rollers, and
rotational axes of the plurality of first tapered rollers are inclined so as to approach the drive shaft from the one end of the drive shaft toward the other end thereof.

9. The electric drive device according to claim 1, wherein the second shaft support portion is a second tapered roller bearing arranged closer to the other end side of the drive shaft than the first shaft support portion, and including a second outer ring supported by the case, a second inner ring coupled to the other end of the drive shaft, a plurality of second tapered rollers arranged between the second outer ring and the second inner ring, and a second retainer retaining the plurality of second tapered rollers, and
rotational axes of the plurality of second tapered rollers are inclined so as to approach the drive shaft from the other end of the drive shaft toward the one end thereof.
